(19) United States
(12) Patent Application Publication
(10) Pub. No.: US 2013/0073815 A1
(43) Pub. Date: Mar. 21, 2013

(54) FLEXIBLE COMMAND PACKET-HEADER FOR FRAGMENTING DATA STORAGE ACROSS MULTIPLE MEMORY DEVICES AND LOCATIONS

(71) Applicant: Ronald R. Shea, Sherman Oaks, CA (US)

(72) Inventor: Ronald R. Shea, Sherman Oaks, CA (US)

(21) Appl. No.: 13/236,584

(22) Filed: Sep. 19, 2011

(51) Int. Cl. G06F 12/00

(52) U.S. Cl. 711/154; 711/E12.001

(57) ABSTRACT

A memory system has a plurality of memory devices and a memory controller coupled to one another in a chain. A packet transmitted through the chain includes a flexible command packet header identifying at least two non-sequential memory devices to be accessed, bypassing interim devices in the chain. The flexible command packet header also allows data to be fragmented in non-sequential memory locations within a memory device, and to be stored non-symmetrically (in different addressable locations among separate memory devices). The flexible command packet header does not have a fixed number of words, but is flexibly configurable to address various numbers of memory devices and various numbers of memory areas within the memory devices.

### RELATED APPLICATIONS

The application incorporates by reference U.S. Provisional Application No. 61/372,860 “MEMORY CHAIN WITH FLEX-COMMAND HEADER FOR INTER-DEVICE AND INTRA-DEVICE DATA FRAGMENTATION AND RETRIEVAL” by Ronald R. Shea. This application also incorporates by reference in its entirety, U.S. Pat. No. 7,308,524 B2 to Grundy, issuing on Dec. 11, 2007.

### FIELD OF THE INVENTION

The present invention relates generally to the field of data processing, and more particularly to command functions governing high-speed memory systems and components of high-speed memory systems.

### BACKGROUND

In response to inexorable demand for faster data throughput and larger storage capacity, memory systems have progressed from asynchronous to synchronous designs and more recently from multi-drop bus topologies to point-to-point systems. FIG. 1, for example illustrates a prior-art memory system 70 in which memory devices 73 are coupled to a memory controller 71 via a multi-drop bus 75. Although such systems offer the advantage of relatively simple and inexpensive expansion through connection of additional memory devices to the multi-drop bus, each additional device connection reduces signaling margin (i.e., due to increased bus capacitance and number of stubs) and therefore the peak transfer rate of the system. Thus, designers of multi-drop memory systems must usually compromise between system capacity and data throughput.

FIG. 2 illustrates a prior-art memory system 80 in which memory devices 83 are coupled to a memory controller 81 via respective point-to-point links 85. Such systems offer the advantage of extremely fast signaling rates, but at the cost of more complex and limited expandability. That is, as each new memory device is added to the system, additional input/output (I/O) pins and corresponding I/O circuitry are consumed within the memory controller so that, for a given generation of memory devices, the maximum storage capacity of the memory system is typically limited by the memory controller itself.

FIG. 3 depicts a prior art memory-chain 100 such as described in U.S. Pat. No. 7,308,524 to Grundy, entitled “Memory Chain,” which is incorporated by reference in its entirety. The memory chain 100 of FIG. 3, allows for a greater import of data per unit of time than the embodiment of FIG. 1, and provides for flexible expansion that was not possible in FIG. 2. The memory chain embodiment includes a set of memory devices 107₁-107_{N} coupled one to another in a chain of point-to-point signaling links, with initial and final devices of the chain (107₁ and 107_{N}, respectively) being coupled to a memory controller 101. In the embodiment of FIG. 3, each of the memory devices 107₁-107₈ is assigned a progressively higher device ID according to its position within the memory chain.

The memory controller of FIG. 3 issues commands and addresses to individual memory devices or groups of memory devices in accordance with the capabilities of the target device or group of devices. Commands and data output from the memory controller 101 to the chain of memory devices 107 travel in one direction, first being received at the initial memory device 107₁ and then being retransmitted to the next memory device in the chain (i.e., 107₂) which receives and retransmits in the same manner. By this operation, commands and data propagate through the chain of memory devices 107, being received and retransmitted by each memory device 107 in turn, until being returned to the memory controller 101 by the final memory device 107_{N}. Each of the memory devices monitors the commands that propagate through the memory chain to determine if the commands require responsive action (e.g., data read, write and erase actions, parameter query response, status response, etc.). As a matter of nomenclature, a given memory device 107ᵢ is referred to as receiving data and commands from an upstream memory device 107ᵢ₋₁ and retransmitting data and commands to a downstream memory device 107ᵢ₊₁. In the case of the initial memory device 107₁, data and commands are received directly from the memory controller 101 and, in the case of the final memory device 107_{N}, data and commands are transmitted directly to the memory controller 101.

FIGS. 4 and 5 respectively depict prior art “short form” and “long form” command packets for use in conjunction with prior art memory-chain embodiments. The only distinction between the prior art “long form” and “short form” command packets is the absence of a starting address in the short form command packet. This distinction was crafted because a configuration command, such as writing a network address into a network-address field, would, by the architecture of the memory device, be directed to a predetermined memory area separate from the data storage portion of the memory device. As a consequence, commands related to the configuration of a memory module would not need to specify a memory area to which such data would be written. In contrast, WORDS 5-9 of the prior art long form command packet of FIG. 5 are used to store the first address of the data-storage area to which the read or write command is directed. Apart from the presence of WORDS 5-9 in the long form command packet, these two prior art command packets were identical, the features of which are further described below.

WORD 1 of both prior art command packets identified the first memory device to which a command was directed, and WORD 2 was directed to the last memory device to which the command was directed.

WORD 3 of both prior art command packets contained a bit distinguishing between long form and short form command packets (the most significant bit in the figure) and a “Data Pickup ” bit (the next most significant bit). The remaining six bits of the command word 205 were used to specify particular commands including, without limitation, read, write, erase and refresh commands. In general read, write and erase commands were issued in long-form command packets 220 as memory addresses are typically provided with such commands.

WORD 4 of the command packet (referred to herein as a word count value) is used to specify the total number of data words (and therefore the number of data packets) that follow the command. WORD 4 is used to specify the size of the data payload being written to or read. In alternative embodiments, this payload size could identify the amount of data being written into or read from each individual memory device addressed by the command packet, or the total volume of read or write data associated with the command.

Transmission of a short-form command packet 203 or long-form command packet 220 may be followed by one or more data packets, such data packets being, in effect, appended to the end of the command packet transmission. FIG. 4 illustrates the format of an exemplary data packet 207 having S constituent data words.

FIG. 6 illustrates a long form READ command directed to memory devices 4, 5, and 6. WORD 1 of the command packet identifies the starting memory device as device number 4. WORD 2 identifies the end memory device as device number 6. WORD 3 identifies the command as a READ command. WORD 4 indicates that the length of data to be read from each memory device is four words. WORDS 5-9 store the starting address at which the READ command is to commence in each of the respective memory devices.

An advantage of the command structure introduced by U.S. Pat. No. 7,308,524 is that the long form command packet allowed a single command to store or retrieve data from a plurality of memory devices. However, multiple limitations inhere from this command packet architecture.

A first limitation of the prior-art command-packet architecture depicted in FIGS. 4-6 is that it could only store or retrieve data from a sequence of consecutive memory devices in a chain. It cannot “fragment” data read or write commands among non-consecutive memory devices in the chain.

A second limitation of the prior-art command packet architecture of FIGS. 4-6 is that all memory devices addressed by the command are required to utilize the same memory addresses for data storage or retrieval. The command specified a starting address that was uniformly imposed on all memory devices addressed by the command. If one of the memory devices has a bad sector in the targeted memory area, the command will not function.

A third limitation of this prior-art command-packet architecture was that it could not fragment data across nonconsecutive memory areas of a single memory device. It provided a starting address, and an amount of data to be written or read.

The full extent of these limitations will be better appreciated in conjunction with FIG. 7, which depicts data storage in real world conditions and applications.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1 illustrates a prior-art memory system in which memory devices are coupled to a memory controller via a multi-drop bus;

FIG. 2 illustrates a prior-art memory system in which memory devices are coupled to a memory controller via respective point-to-point links;

FIG. 3 illustrates a prior art memory system incorporating a chain architecture in which multiple memory devices are linked in a memory chain;

FIG. 4 depicts a prior art “short form” command packet used in conjunction with the prior art memory chain of FIG. 3.

FIG. 5 depicts a prior art “long form” command packet used in conjunction with the prior art memory chain of FIG. 3.

FIG. 6 illustrates an exemplary long-form command packet directed to a range of memory devices within the memory system of FIG. 3.

FIG. 7 depicts the internal memory area and various data arrays stored therein, within a plurality of memory devices linked in a chain according to the architecture of FIG.3.

FIG. 8 depicts an embodiment of a flexible fragmentation command packet.

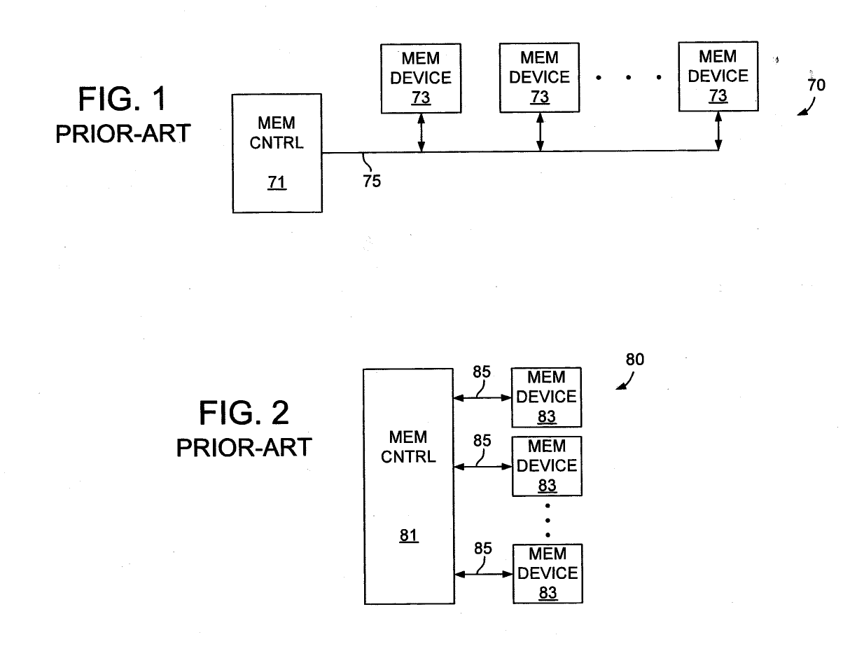

### DETAILED DESCRIPTION OF THE SEVERAL VIEWS OF THE DRAWINGS

The embodiments described herein relate to the storage and retrieval of data. As used within this specification, including the appended claims, the term “data transmission within a memory system” refers to one or more of the following processes: data storage within a memory system, data retrieval from a memory system, and erasure of data from one or more memory devices of a memory system. Similarly, the term “accessing a memory device” refers to refers to one or more of the following processes: data storage within the memory device, data retrieval from the memory device, and erasure of data within memory device.

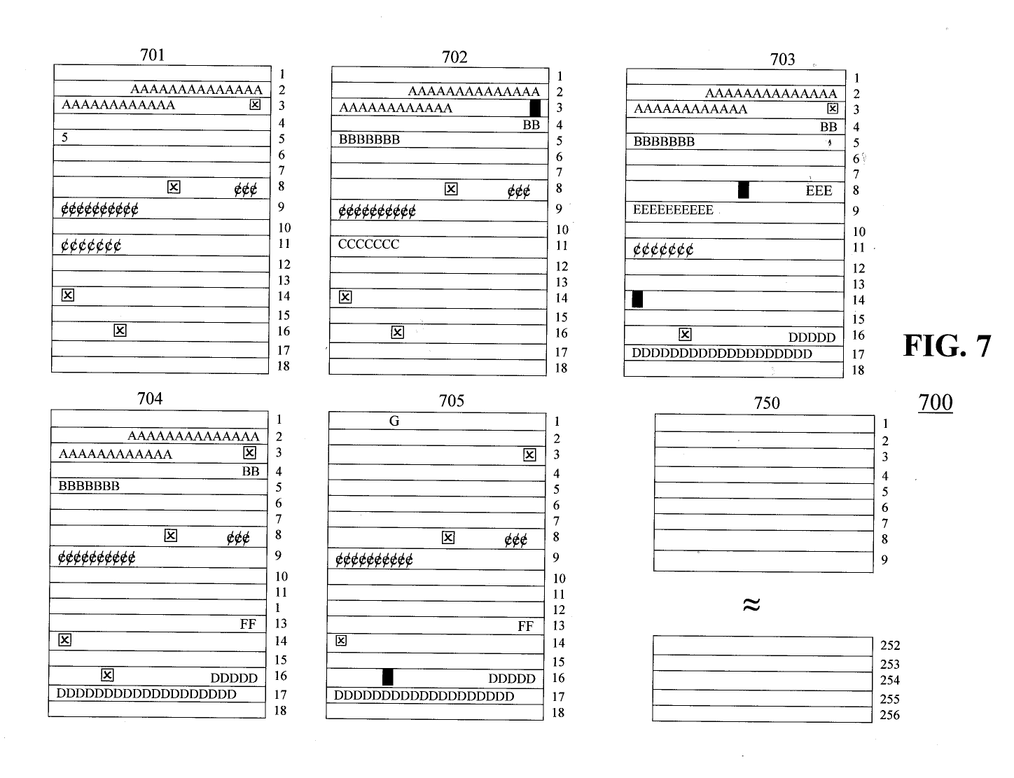

As FIG. 7 illustrates five memory devices 701-705 coupled in a common memory chain 700. Vertical numbering of rows represents sequential rows, each row having the same storage capacity. Each row has a uniform plurality of blocks, each block representing a uniform storage capacity. The use of the term “block” is not intended to limit the storage space represented therein to any particular unit of storage, and is intended in its broadest interpretation. Accordingly, each block (such as those identified by a single letter representing part of a Data-Set) can be any particular storage capacity. Whether each square is a single bit, or a gigabyte of memory, is not essential to the concepts being illustrated.

Blocks filled with identical letters of the alphabet represent a single “set” of related data distributed among a plurality of blocks, and/or a plurality of memory devices. For example, data array “AAAAAAA” can represent a Blu-Ray movie. The first third of the video portion is distributed across the second and third words of blocks 701. The second third of the video portion is distributed across the second and third words of block 702. The final third of the video portion is distributed across the second and third words of block 703. The audio portion is distributed across the second and third words of block 704.

Blocks filled with a dark square depict a damaged block to which the memory controller cannot write. Squares with an “X” in them represent “virtual damaged blocks,” as explained further below.

Data representing Data-Set “B” has been distributed among multiple blocks of rows 4 and 5 of memory devices 702, 703, and 704. Data representing Data-Set “C” has been distributed among seven blocks of part of a row 11 in memory device 702. Depending on the nature of the prior art long-form command packet, Data-Set C also forms “virtual data” 0000000 in adjacent memory devices. Data representing Data-Set “D” has been distributed among multiple blocks at the end of row 16 and most of row 17 in memory devices 703, 704, and 705. Data representing Data-Set “E” has been distributed in rows 8 and 9 of memory device 703. Data representing Data-Set “F” has been distributed among a single block of two adjacent memory devices, 704 and 705, in the far right hand block of row 13. Data-Set G has been stored in a single block of row 1 of memory device 705. The term “Data-Set” is used to represent that the data was stored by a single Command Packet.

The prior art long form command packet allowed memory storage and retrieval to be spread among multiple memory devices. As noted, however, storage and retrieval processes implemented pursuant to the long-form command packet have a variety of architectural limitations.

A first factor limiting data storage according to the long form command packet is that a command distributing data among multiple memory devices must utilize consecutive memory devices. It cannot skip a memory device.

A second limiting factor is that data stored in consecutive memory devices must be stored in the same addressable blocks of all of those memory devices. It cannot tailor data storage to the available memory of each individual memory device.

Finally, a single command cannot fragment data in two discontinuous memory areas of the same memory device. Data from a single long form command packet must be stored in consecutive addressable memory blocks or areas within an individual memory device. A single long form packet cannot direct storage or retrieval from multiple discontinuous memory areas. The command may not skip a bad block, or a memory area in which data is already stored, and resume storage in a subsequent block.

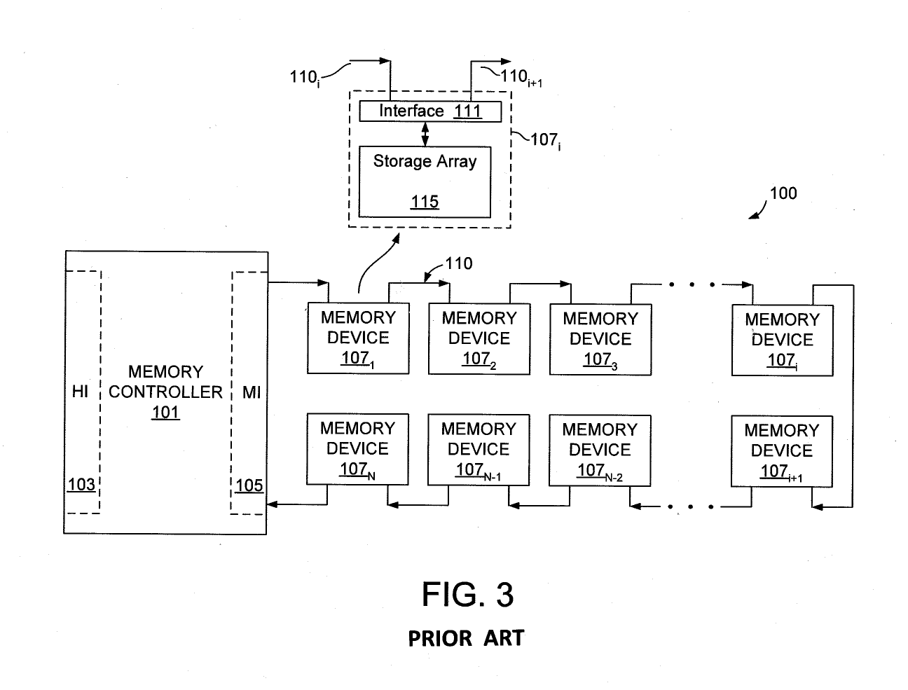

The catastrophic implication of these limitations can be better illustrated by first examining the data storage arrays in FIG. 7, and considering the functional limitations these data arrays impose on a system using a prior art command packet. Memory devices 701-705 are understood as being consecutive memory devices in a chain as depicted in FIG. 3.

“Data-Set A” has been stored in memory devices 701 through 704, across the last portion of row 2 and a first portion of row 3. A darkened area near the end of row 3 of memory device 702 represents a damaged area of memory. A prior art long form Command Packet may store data within row three of memory device 702, in the region between Data-Set A and the damaged (darkened) memory area. However, the prior art long form Command is limited to continuous data storage up to the block immediately preceding the damaged block of row 3. It cannot “skip” or “bypass” the damaged memory area and continue data storage at the end of the row three, and continuing on in row 4. Such fragmentation can only be achieved by two separate long-form command packets. However, a major advantage of the physical architecture of a memory chain of FIG. 3 over prior art embodiments was the ability to write to multiple memory devices by a single command. As a consequence, with a view toward the damaged sector of memory device 702, word 3, the prior art long-form command packet could not “skip” the damaged sector, and store data continuously from the end of Data-Set “A” to the beginning of Data-Set “B”. The same limitation exists whether a block of memory is damaged, or filled. For example, referring still to memory device 702, a long form Command Packet also cannot store data in row 4 up to “Data-Set B,” bypass Data-Set B, and commence storage in row 5 of memory device 702.

Still referring to FIG. 7, a damaged block or sector in one memory device can also act as “virtual damaged block” in adjacent memory devices within the memory chain. When storing data across multiple memory devices, the prior art long form Command Packet was required to store a “Data-Set” within the same data areas of multiple consecutive memory devices.

For example, referring to memory device 703, there a long form Command Packet can direct a write operation to fill the blocks from the final “A” data entry to the first “B” data entry. And in this operation, a long form Command Packet can distribute the Data-Set among memory devices 703, 704 and 705 without impediment by the bad block of device 702. The “virtual bad blocks” duplicating any bad blocks of device 702 do not exist in this case.

However, the Long Form Command Packet cannot skip blocks within a memory device, and cannot jump over memory devices. Therefore, any Long Form read or write command addressed to memory device 702 is limited to a region before or after the damaged block of row 3. It cannot read or write to blocks before and after the damaged block. Accordingly, for any Long Form Command directed to a group of memory devices including memory device 702, the block address of the damaged block becomes a “virtual bad block” in all other memory devices addressed within the command. That block address becomes inaccessible in all memory devices addressed by the Long Form Command Packet. Data may be stored prior to the damaged block (and “virtual damaged blocks”) or subsequent to them. It may not include them, and may not jump over them. Two separate command packets will be required to store data before and after the damaged block.

As a memory device ages, the number of damaged blocks or damaged sectors can only remain level or increase. Additionally, a memory device will progressively fill with data over a period of time. As a consequence, the process of data storage itself may result in fewer and fewer consecutive data areas of optimal length that will remain available, forcing the memory controller to invest an increasing amount of overhead searching for consecutive regions of available memory of an optimal length. For example, Data-Set E is found only in device 703. Without this Data-Set, consecutive memory devices including devices 702 and 703 could store data, beginning at the block that immediately follows the bad block of row 8 (see memory device 703), and continuing to the first block of row 11, where, in adjacent memory device 702, the “CCCCC” data begins. However, because the Long Form Command Packet cannot skip memory device 703, if it is included in a write command, Data-Set C and E are illustrated as forming a virtual Data-Set in adjacent memory areas, virtual Data-Set C as represented by the null 0 and virtual Data-Set E the null 0 in adjacent memory devices. To utilize consecutive devices that include memory device 702 or device 703, these regions storing virtual Data-Sets would be unavailable. As a consequence, as the memory devices fill up with data or bad sectors, the size of available continuous storage areas in consecutive memory devices will become smaller and smaller. This limitation will further govern the word count of a write command, requiring write commands of sub-optimal word length, thereby increasing the overhead required by the memory controller to identify a suitable sequence of available storage locations within consecutive memory devices. This overhead will require not only increasingly detailed algorithms to govern memory storage, but an increasing amount of time to perform each overhead calculation, and identify the “most optimal” storage areas requiring the fewest number of command packets.

As a result of the limitations imposed by the prior art command packet architecture, the memory controller cannot first determine an optimum length of data to store in each memory device by a single command, and then identify the available memory areas for storing that data. Rather, the memory controller must first indentify continuous storage areas within sequential memory devices, each storage area beginning and ending at the same addressable block of the various memory devices, and then select an amount of data to be written or read according to this size limitation. The payload size is therefore limited by the shortest continuous segment of available memory among any of those memory devices being targeted.

In the prior art, this dilemma can only be resolved by the use of multiple separate commands, thereby eliminating the specific advantage of addressing multiple memory devices in a single command. That is, two prior art long form command packets can be used to completely skip over memory module 702. A first long form command packet directs data storage to memory module 701, and a second command packet directs data storage to memory modules 703 through 705. A read command that does not include memory device 702 is not impeded by the presence of a bad block in device 702. As noted, however, this process requires two separate long form command packets.

Although multiple command packets can resolve some of these limitations, as shown above, such a solution circumvents the advantage of being able to direct the storage of an entire data chunk by means of a single Command Packet. Moreover, the demands imposed on the memory controller by these limitations may impede optimal performance of the memory chain.

In a similar manner, pre-existing data stored in a block or address range of one memory device functions as “virtual data” in the same addressable range of the other memory devices, just as a bad block duplicated itself into a “virtual bad block.” A single long form command packet of FIG. 5 cannot skip over the block or a range in which the pre-existing data has been stored. Neither can it skip over the entire memory device containing the pre-existing data. As with a damaged block, the limitation of “virtual data” may be circumvented by multiple write commands. But a single long form command packet cannot perform this function.

Although the extent to which these limitations impeded the optimal functioning of a memory chain would depend upon a variety of assumptions, it can be readily appreciated that these limitations would increasingly manifest themselves proportional to at least four variables:

1) the number of damaged blocks present somewhere within memory devices of the memory chain;

2) a percent of the total memory being used for data storage;

3) the number of distinct unused data blocks bracketed by stored data; and

4) the size of a Data-Set selected for storage within the memory chain on a given write command.

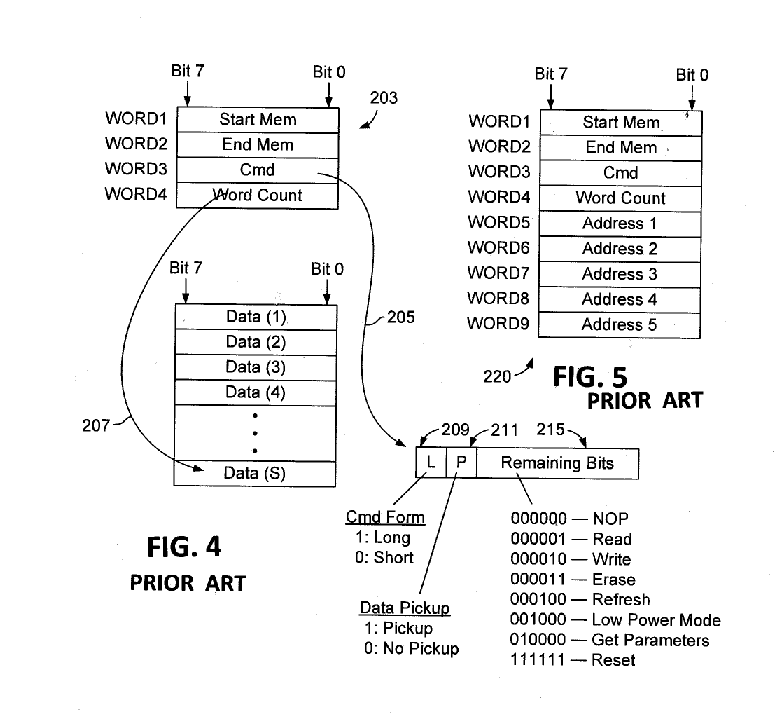

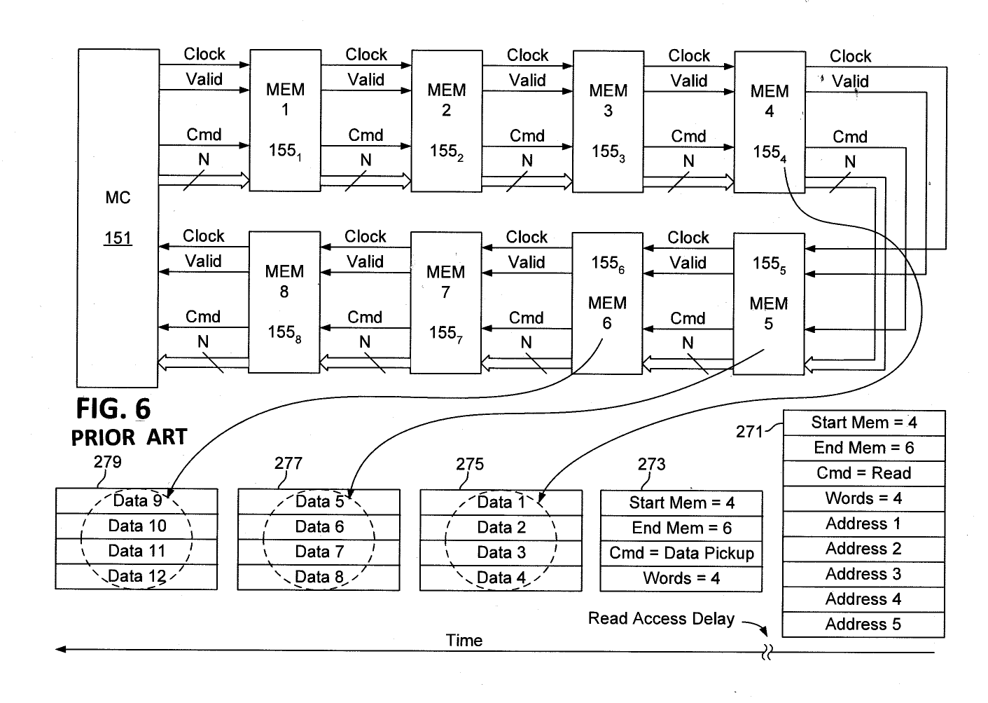

Another limitation of the command packets of FIGS. 4 and 5 can be appreciated by considering the addition of memory device 750 to memory chain 700. The address range of memory devices 701-705 is eighteen “words.” The addressable range of memory device 750 is two hundred fifty six words. When a single long form command packet, as shown in FIG. 5, addresses multiple memory devices, the read, write, or erase command is directed to the same addressable range in all of the memory devices. When such long form commands are utilized, anything beyond word eighteen is outside of the addressable range in memory devices 701 through 705. As a consequence, none of this memory can be included in a long form command packet that includes any of the first five memory devices. It can only be addressed by a long form command packet dedicated to memory device 750. Again, this limitation negates one of the advantages of the memory chain, which is to be able to store and retrieve a Data-Set distributed across a plurality of memory devices through a single command.

It can be readily appreciated, therefore, that the advantages of the memory chain described herein can be optimized by a command protocol that allows a single command packet to fragment a Data-Set across a non-continuous array of blocks within an individual memory device, thereby skipping blocks which are damaged or already contain data.

The advantages can further be optimized by providing a single command packet to fragment data over a discontinuous array of memory within a given memory device, skipping one or more memory devices.

Finally, flexibility of a command packet can be further enhanced by allowing data storage at different locations among the memory devices addressed by the Command Packet, rather than requiring the same data fields to be used in all of the memory devices.

Straightforward implementation of these objectives, however, would require large bandwidth consumption in every command packet. Even then, limitations could remain inherent. For example, instead of a single word (field) identifying a first memory device in a sequence, and a second word (field) for identifying a second memory device of a command, a predetermined number of separate words could be set aside, allowing the address of multiple distinct memory devices to be written therein. The disadvantages of this technique, however, continue to degrade optimal system performance. System performance is enhanced as the command packet is kept small. However, system flexibility is increased by allowing for a command packet to address the greatest number of memory devices in the chain.

In a similar manner, each prior art command packet could reserve multiple words sufficient for a predetermined number of “start addresses” into which data could be fragmentally stored or read. For example, instead of a field (or multi-word field) for identifying a first addressable area of a memory device, a predetermined number of separate fields could be reserved, allowing the address of multiple distinct memory devices to be written therein. The disadvantage of this technique, however, is that an increase in the number of fields wastes overhead space in a command packet . . . particularly if those fields are not filled or utilized in a transmission. System performance is enhanced as the command packet is kept small. However, system flexibility is increased by allowing for a command packet to address the greatest number of memory areas within a memory device, if needed to store a “set” of data through a single transmission.

Finally, it can be readily appreciated that, using a simple addressing scheme such as depicted in the prior art command packet of FIG. 5, more memory must be reserved to formulate a command header to allow a single command to store data at different locations in different memory devices.

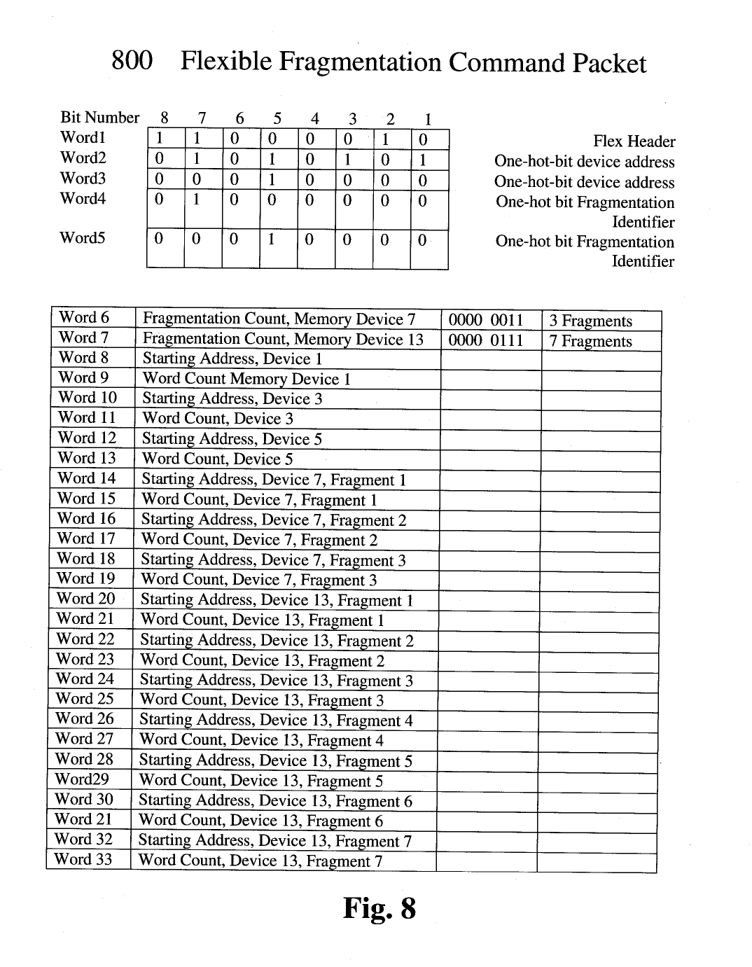

FIG. 8 depicts an improved long form command packet in the form of a Flexible Fragmentation Command Packet (FFCP) 800. This FFCP is configured to allow a single command packet to read data from, or write data into any number of non-consecutive memory devices within a memory chain, and to fragment data read or write commands across any number of non-continuous data storage areas within a memory device without reserving a “fixed” amount of overhead space in a command header sufficient to accommodate all of the potential addresses.

WORD 1 of FIG. 8 depicts an embodiment of a “Flex-Command Header.” In an embodiment, specific bits within the Flex-Command Header (Word 1) determine the meaning of the remaining words. To illustrate this concept, a specific value is given to WORD 1, and the meaning of this value is explained. As discussed below however, various data patterns in the Flex-Command Header (WORD 1) can alter the function of WORD 2, and therefore, all subsequent words in the Flexible Fragmentation Command Packet.

For illustrative purposes only, each word within the fragmentation packet is depicted as one byte. Each word could include a greater number of data bits, including, but not limited to, sixteen bits or thirty two bits. Additionally, each word could contain extra bits for parity check, or other error checking or overhead functions.

As discussed below, the bits of certain words in this Command Packet will correspond with individual memory devices. Because it is more intuitive to refer to a memory device and its corresponding bit by the same number, and it is also more intuitive to refer to the first memory device as “device 1” rather than “device 0,” the addressing scheme adopted in FIG. 8 identifies the bits of a word as “bits 1-8” rather than bits “0-7.” References to previous figures will adopt the addressing system of those figures.

The Flexible Fragmentation Command Packet depicted in FIG. 8 is configured fragment data across non-sequential memory devices, and also across non-sequential addresses within a memory device. However, packet embodiments are envisioned that can be directed to only one of these forms of fragmentation. It is flexible in that the command packet can be configured to read or write to a memory chain of any length of memory devices, and having any number of fragmented storage locations within the various memory devices.

Momentarily returning to FIG. 3, which has eight memory devices in a chain, it will be recalled that a memory chain may be comprised of any number of memory devices, and that these can be added or removed. A reconfiguration command can then be issued to re-number the memory devices to include the newly added memory devices.

TABLE 1 describes the function of the most significant bit of WORD 1 of the Flexible Fragmentation Command Packet 800 of FIG. 8. Within TABLE 1, the eight bits are described as bits “1-8” rather than “0-7” for consistency of description, wherein the “sixth bit” coincides with bit six, and not bit 5. As described in TABLE 1, the most significant bit 8 of WORD 1 of FIG. 8 determines if the command packet is a prior art “short form” packet, or the Flexible Fragmentation Command Packet that incorporates the features of words 2-33 in FIG. 8.

TABLE 1

| Packet Type | Bit 8 |
|---|---|
| Short Form Packet | 0 |
| Flexible Fragmentation Command | 1 |
| (Long Form) Packet | |

Still referring to WORD 1 of FIG. 8, TABLE 2 below depicts an embodiment in which bits 7 and 6 of the flex-header (WORD 1) identify the number of words within the Flexible Fragmentation Command Packet that are required to individually address each of the memory devices within the chain through a one-hot-bit addressing format.

TABLE 2

| Meaning | Bit 7 | Bit 6 |
|---|---|---|
| Word 2 addresses memory devices. | 0 | 1 |
| Fragmentation Identifier commences in WORD 3 | | |
| Words 2 & 3 addresses memory devices. | 1 | 0 |
| Fragmentation Identifier commences in WORD 4 | | |
| Words 2, 3 & 4 address memory devices. | 1 | 1 |
| Fragmentation Identifier commences in WORD 5 | | |
| Word 2 identifies the number of memory devices | 0 | 0 |
| in the chain. | | |

By the above table, the binary value 01 indicates that only one word of memory (WORD 2) is used to identify memory devices. As discussed below, memory devices are represented by a single bit. The presence of binary value 01 in bits 6 and 7 therefore indicates that the chain comprises eight or fewer memory devices.

Within bits 6 and 7, the binary value 10 indicates that the next two words of the Flexible Fragmentation Command Packet 800 (WORDS 2 and 3) are reserved for addressing the memory devices within the chain. This is the example depicted in FIG. 8. Accordingly, within FIG. 8, two eight-bit words (WORDS 2 and 3) are dedicated to identifying and addressing up to sixteen separate memory devices, each bit of WORDS 2 and 3 corresponding to a memory device.

The binary pattern 11 indicates that the next three words (WORDS 2, 3 and 4) of the Flexible Fragmentation Command Packet are reserved for addressing the memory devices within the chain, thereby permitting addressing of up to twenty-four separate memory devices.

The binary pattern 00 within bits 6 and 7 of WORD 1 indicates that four or more words are necessary to identify each memory device by a one-hot-bit addressing format. When this occurs, one-hot-bit addressing (described below in TABLE 3) does not commence in WORD 2. Rather, WORD 2 represents in standard binary format how many words are needed to address all of the memory devices within the memory chain by a one-hot-bit addressing scheme. In this case, the actual one-hot-bit addressing of the memory devices will then commence in WORD 3, not WORD 2.

Assuming, for example, a 00 pattern in bits 6 and 7 of WORD 1, a binary value of 0000 0110 (equivalent in binary to the decimal value “six”) in WORD 2 would indicate that the following six words (WORD 3-WORD 8) are reserved for one-hot-bit addressing of memory devices. As noted, individual bits in these words represent separate memory devices. Using, for purposes of example, that each word is one byte, six words would contain forty-eight bits, meaning that WORDS 3-8 could address up to forty-eight memory devices.

Referring to the example depicted in FIG. 8, the binary value shown in bits 6 and 7 of WORD 1 is “10,” indicating that the next two words of the command packet (WORDS 2 & 3, collectively described as the “Device Addressing Field”) are used for addressing memory devices via a “one-hot-bit” address scheme described in TABLE 3, and WORDS 4 & 5 identify, using a “one-hot-bit” addressing scheme of TABLE 3, in which the memory devices receiving “fragmented” data are identified.

According to the proposed architecture, bits 6 & 7 of WORD 1 determine whether WORD 2 begins addressing individual memory devices, or alternatively, whether WORD 2 defines how many words will be used to address individual memory devices, and packet length if “flexible.” If Bits 6 and 7 of WORD 1 were a binary “11,” and WORD 2 contained the equivalent of a decimal value between 56 and 64, the “one-hot-bit-address” (depicted in FIG. 8 as WORDS 2 and 3) would be spread across WORDS 3-10, and the one-hot-bit fragmentation identifier (currently depicted as WORDS 4 and 5 of FIG. 8) would be spread across WORDS 11-18. The Flexible Fragmentation Command Packet is therefore referred to as a “flex” command packet to illustrate that the function and purpose of certain words is dependent on one or more prior words. Because of this flexibility, the packet may be small when addressing few devices, or when little or no fragmentation occurs, but may be flexibly expanded to accommodate any number of memory devices and any amount of fragmentation within a memory device.

Bits 1 through 5 of WORD 1 of FIG. 8 can be used for a variety of other functions, but preferably include identifying the packet command functions such as READ, WRITE, ERASE, REFRESH, etc.

In the prior art long form command packet depicted in FIG. 5, an entire word was devoted to the addressing of a single memory device, representing the “device address” in digital form. WORD 1 identified the device address of the “starting” memory device, and WORD 2 identified the device address of the “End” memory device in the sequence.

TABLE 3 describes the “one-hot-bit” addressing used to identify memory devices within the Flexible Command Packet 800 of FIG. 8. In a “one-hot-bit” addressing scheme, individual memory devices are addressed by a single bit, rather than an entire word, as in the prior art long form command packet of FIG. 5. The center column of TABLE 3 has nine rows corresponding to memory devices 1 through 9, as displayed in standard base ten addressing. The tenth row references five separate memory devices: 1, 3, 6, 7 and 8, in base ten. The left hand column displays the corresponding binary address required to identify the device of the center column. The entire eight bit field is needed for memory devices 1-8. The right hand column displays the corresponding addresses according to a “one-hot-bit addressing scheme. Only a single bit in the right hand column is required to identify (or “address”) the corresponding memory device.

TABLE 3

| Binary Address | Memory Device | “One-Hot-Bit” Address |
|---|---|---|
| 0000 0001 | 1 | 0000 0001 |
| 0000 0010 | 2 | 0000 0010 |
| 0000 0011 | 3 | 0000 0100 |
| 0000 0100 | 4 | 0000 1000 |
| 0000 0101 | 5 | 0001 0000 |
| 0000 0110 | 6 | 0010 0000 |
| 0000 0111 | 7 | 0100 0000 |
| 0000 1000 | 8 | 1000 0000 |
| 0000 1001 | 9 | Can't be |
| | | depicted in |
| | | one byte |
| Can't be | 1, 3, 6, 7, 8 | 1110 0101 |
| depicted in one | | |
| byte | | |

In TABLE 3, memory device “5” is thus represented by the binary value 0000 0101. In contrast, the right-hand column identifies memory device 5 by a single bit. Defining the least significant bit as “bit 1,” memory device “5” is simply addressed by bit 5 in the right hand column. Beginning from the right hand side as the least significant bit, the first bit corresponds to memory device address 1, the second bit corresponds to memory device address 2, and so forth. As a consequence, memory device 5 is depicted by a “true” or “hot” bit in the fifth bit field.

The last two rows of Table 3 illustrate weaknesses and strengths of these alternative addressing schemes. The second-to-last row of Table 3 references a 9^{th} memory device in the center column. A single byte (an eight bit field) can represent a ninth memory address as a binary value, as shown in the left hand column of the ninth row, by the value 0000 1001. In contrast, a “one-hot” bit address scheme of the far right column of Table 3 cannot depict a 9^{th} memory device in a one byte (eight bit) field. It can only address as many separate memory devices as it has bits. In a one-byte (eight bit) field, this means that a one-hot addressing scheme is limited to eight or fewer memory devices. For embodiments including from nine to sixteen memory devices, two bytes are needed for a one-hot addressing scheme. For each additional eight memory devices in a chain, an additional byte is needed in a one-hot addressing scheme.

A strength of the one-hot-bit addressing scheme can be appreciated by the final row of Table 3. In a single byte, the “one-hot-bit” addressing scheme of the right hand column is able to identify any combination of up to eight memory devices being addressed by a command packet. As depicted in row 9, the single byte of data using a one-hot addressing scheme identifies memory devices 1, 3, 6, 7, 8. The reader will note that these are non-consecutive memory devices. By utilizing a one-hot-bit addressing scheme in a command packet, read and write commands can be directed to non-sequential memory devices in an efficient manner that consumes little overhead space in a command packet.

Returning to FIG. 8, WORDS 2 and 3 of Command Packet 800 identify the memory devices which will be accessed by the command packet, using the “one-hot-bit” addressing scheme described in TABLE 3. It is appreciated that the term “access” can refer to read, erase, reset, and other functions. In the “one-hot-bit” architecture of Words 2 and 3, each bit represents a different memory device. In WORD 2, the presence of a true, or hot bit in bit addresses 1, 3, 5 and 7 indicates that the Commanded Packet is addressed to memory devices 1, 3, 5 and 7. In WORD 3, the presence of one-hot-bit in bit address 5, (the 13th bit of the Device Addressing Field) indicates that the command packet is also directed to memory device 13. Through this addressing format, the memory controller can identify any combination of memory devices within the memory chain within a single read, write or erase command packet.

Because Words 2 and 3 identify only memory devices 1, 3, 5, 7 and 13 as being accessed by the command, these are the only memory devices in which this command can possibly fragment the incoming data.

Referring still to FIG. 8, the Fragmentation Identifier Field of WORDS 4 and 5 identify in which of the memory devices identified in WORDS 2 and 3 data will be stored (or retrieved) in a fragmented form. Again, a “one-hot-bit” addressing scheme is used, the bits in WORDS 4 and 5 corresponding to the same memory devices identified in WORDS 2 and 3. Within WORDS 4 and 5, a “1” indicates that data will be fragmented within the corresponding memory device, and a “0” indicates no fragmentation will occur in the corresponding memory device.

According to the example depicted in FIG. 8, the bit pattern of WORDS 4 & 5 shows that no fragmented data storage is directed to occur in memory devices 1, 3 or 5. As a result, each of these memory devices will require only a single Segment Address Field and a single Word Count Field to direct data storage within that device. Throughout this discussion, the depiction of a write command is offered only by way of example, and is not intended to limit the function of command packages to write commands. The functionality described in conjunction with FIG. 8 can be used in whole, or in part, with any command functions, including, but not limited to, write and erase commands.

Because two memory devices (memory device 7 and memory device 13) are identified as being targeted to receive multiple data fragments, a corresponding two words, WORDS 6 and 7 are required to respectively define the number of data fragments (“Fragment Count”) for each of these respective memory devices. Within WORD 6, the binary value “0011” indicates that three data fragments will be stored in (or read from) three distinct addressable areas of memory device 7. Within WORD 7, the binary value “0111” indicates that seven data fragments will be stored in memory device 13.

Following the Fragment Count Words 6 and 7 of FIG. 8, alternating Block Address Fields and Word Count Fields define the starting block address and word count into which each of the data fragments is to be stored. For example, the first memory device into which data was to be written was device 1. WORD 8 identifies the starting address in memory device 1 into which the data is to be written, and WORD 9 indicates the length of data to be written into this memory device.

Referring to the one-hot addressing scheme of WORDS 2-3, the second device into which data was to be stored was device 3. WORD 10 indicates the starting address into which the data is to be stored in device 3, and Word 11 indicates the word count (payload length) that is to be stored in this memory device.

Referring to the one-hot addressing scheme of WORDS 2-3, the third device into which data was to be stored was device 5. WORD 12 indicates the starting address into which the data is to be stored in device 5, and Word 13 indicates the word count (payload length) that is to be stored in this memory device.

Referring to the one-hot addressing scheme of WORDS 2-3, the fourth device into which data was to be stored was device 7. It will be recalled that WORD 4 indicated that fragmentation was to occur in device 7, and that WORD 6 indicated the fragmentation would be across three addressable ranges. WORD 14 indicates the starting address into which the first fragment of data is to be stored in device 7, and Word 15 indicates the word count (payload length) of this first data fragment. WORD 16 indicates the starting address into which the second fragment of data is to be stored in device 7, and Word 17 indicates the word count (payload length) of this second data fragment. WORD 18 indicates the starting address into which the third fragment of data is to be stored in device 7, and Word 19 indicates the word count (payload length) of this third data fragment.

Referring to the one-hot addressing scheme of WORDS 2-3, the fifth device into which data was to be stored was device 13. It will be recalled that WORD 5 indicated that fragmentation was to occur in device 13, and that WORD 7 indicated the fragmentation would be across seven addressable ranges. WORD 20 indicates the starting address into which the first fragment of data is to be stored in device 13, and Word 21 indicates the word count (payload length) of this first data fragment. This process continues across WORDS 22-33 for the other six data fragments to be stored in device 13.

The reader will appreciate that a “word” in FIG. 8 may be various lengths according to system architecture (e.g., 8 bits, 16 bits, etc.) And it will further be appreciated that large storage systems (e.g. in the terabyte range) may require multiple words to contain a single “starting address” for data storage. Within FIG. 8, WORDS 8-33, the use of a single word for each “starting address” and a single word for each “word count” (payload length) is not intended to limit the appended claims to this architecture. In an architecture wherein each of words 1-33 was only 8 bits, and wherein system addresses ranged into the terra-byte range, many words would be needed to identify a single starting address. The use within FIG. 8 of a single word for each address and each payload length is therefore simply illustrative, and not intended to limit the appended claims, or the system architecture in which a Flexible Command Packet can be utilized.

Descriptive Clauses

The following clauses further describe the operation of flexible command packet header in conjunction with a memory chain as described herein.

CLAUSE 1: A method for accessing, through a memory access command, at least two memory devices within a memory chain having at least three memory devices, the method comprising:

receiving the memory access command by a first memory device;

accessing a first memory area of the first memory device according to an instruction in the memory access command;

transmitting the memory access command downstream from the first memory device to a second memory device adjacent the first memory device;

transmitting the memory access command downstream from the second memory device without accessing a memory area in the second memory device;

receiving the memory access command in a third memory device downstream from the second memory device; and,

accessing, according to an instruction in the memory access command, a first memory area of the third memory device.

CLAUSE 2: A method according to CLAUSE 1, further comprising accessing, according to an instruction in the memory access command, a second memory area in the first memory device, the first memory area being addressable by a first sequence of addresses, and the second memory area being addressable by a sequence of addresses, wherein the first sequence of addresses is separated from the second sequence of addresses by an interim sequence of addresses.

CLAUSE 3: A method according to CLAUSE 1, wherein memory areas of the first memory device and the third memory device comprise identical addressing schemes, the first memory area of the first memory device being identified by a first sequence of addresses, wherein the memory access command bypasses the first sequence of addresses of the third memory device.

CLAUSE 4: The method according to CLAUSE 1, wherein the memory access command uses a single bit to identify memory devices in which the memory is to be accessed in a fragmented manner.

CLAUSE 5: A method for accessing, through a memory access command, a plurality of memory areas distributed among a chain of memory devices, the method comprising:

receiving the memory access command by a first memory device;

accessing a first memory area of the first memory device according to an instruction in the memory access command; and,

accessing a second memory area of the first memory device, the first memory area being addressable by a first sequence of addresses, and the second memory area being addressable by a sequence of addresses, wherein the first sequence of addresses is separated from the second sequence of addresses by an interim sequence of addresses.

CLAUSE 6: A method according to CLAUSE 5, wherein the memory chain comprises a downstream memory device having an addressing scheme identical to the first memory device, the method further comprising:

transmitting the memory access command downstream the memory chain from the first memory device;

receiving the memory access command by the downstream memory device;

accessing, according to an instruction in the memory access command, a memory area the downstream memory device; and,

bypassing, according to the memory access command, the first sequence of address in the downstream memory device.

CLAUSE 7: The method according to CLAUSE 5, wherein the first memory device is identified by a single bit in the memory access command.

CLAUSE 8: The method according to CLAUSE 5, wherein the memory access command uses a single bit to identify memory devices in which the memory is to be accessed in a fragmented manner.

### CONCLUSION

Through the above described embodiments, a Flexible Fragmentation Command Packet can be configured to store data at a single addressable area within a single memory device, or multiple discontinuous addressable areas within a memory device. The same Command Packet may also target different addressable areas of separate memory devices for data storage, and may identify any combination of memory devices within a chain for storage of some or all of a Data-Set being transmitted, including non-consecutive memory devices. By this flexibility, the presence of damaged blocks, the presence of stored data, the different available addresses in adjacent memory devices, and the size of the available empty data storage areas in various memory devices does not hinder the storage of data through the various embodiments of the memory chain described herein. A more optimal functionality of a memory chain is therefore retained as the memory devices are filled progressively with data, and progressively suffer increasing numbers of damaged blocks.

1. A flexible command packet for controlling an accessing of select memory devices within a memory system, the command packet comprising configuration data for accessing, through a single command, a combination of non-sequential discrete memory devices from among a plurality of discrete memory devices within the memory system.

2. The flexible command packet of claim 1, wherein the memory system comprises a chain architecture coupling together the plurality of discrete memory devices in a chain.

3. The flexible command packet of claim 2, wherein the combination of non-sequential discrete memory devices are architecturally non-sequential according to their relationship to each other within the chain.

4. The flexible command packet of claim 1, wherein each of the discrete memory devices within the memory system is identified by a unique binary address, and wherein the combination of non-sequential discrete memory devices are identified by non-sequential binary addresses.

5. The flexible command packet of claim 1, further comprising a memory-device-count field indicating a quantity of memory devices within the memory system.

6. The flexible command packet of claim 5, wherein the memory-device-count field contains a binary value defining a quantity of memory devices within the memory system.

7. The flexible command packet of claim 5, further comprising a memory-device-correspondence-field, each memory device within the memory system corresponding to a single-bit-field within the memory device correspondence field, wherein a size of the memory-device correspondence-field is flexibly configurable according to the binary value stored in the memory-device-count field.

8. The flexible command packet of claim 1, further comprising a memory-device-correspondence-field, each memory device within the memory system corresponding to a single-bit-field within the memory device correspondence field.

9. The flexible command packet of claim, wherein a first binary value within a single-bit-field of the device-correspondence-field indicates that a corresponding memory device is to be accessed according to a command within the flexible command packet, and wherein a second binary value within the single-bit-field indicates that the corresponding memory device is not to be accessed according to the command within the command packet.

10. The flexible command packet of claim 9, further comprising a device-fragmentation correspondence-field with data identifying which of the plurality of discrete memory devices, if any, are to be accessed in at least two non-sequential memory areas.

11. The flexible command packet of claim 10, wherein a single-bit-field within the device-fragmentation correspondence-field corresponds to a memory device among the plurality of discrete memory devices.

12. The flexible command packet of claim 11, wherein a first binary value within a single-bit-field of the device-fragmentation correspondence-field indicates that at least two non-sequential areas of memory within the corresponding discrete memory device are to be accessed by the command within the flexible command packet, and a second binary value within the single-bit-field indicates that no more than one contiguous area of memory within the corresponding discrete memory device is to be accessed by the command within the flexible command packet.

13. The flexible command packet of claim 12, wherein a size of the-device-fragmentation correspondence-field is flexibly configurable according to a quantity of memory devices in the memory system.

14. The flexible command packet of claim 1, further comprising a plurality of fragmentation count fields, each fragmentation count field corresponding to a discrete memory device within the memory system, wherein a digital value stored within fragmentation count field indicates a number of separate memory areas of the corresponding discrete memory device that are to be accessed by a command within the flexible command packet.

15. The flexible command packet of claim 12, further comprising a plurality of fragmentation-count fields, each fragmentation-count field corresponding to a discrete memory device within the memory system, wherein a digital value stored within fragmentation count field indicates a number of separate memory areas of the corresponding discrete memory device that are to be accessed by a command within the flexible command packet.

16. The flexible command packet of claim 15, wherein a number of fragmentation-count-fields corresponds to a number of times the first binary value is stored within a single-bit-field of the device-fragmentation correspondence-field.

17. The flexible command packet of claim 15, further comprising an address field identifying at least one digital address at which access by the flexible command packet is to commence within a corresponding memory device.

18. The flexible command packet of claim 17 wherein an aggregate number of discontinuous memory areas identified for access by the command packet is determined, at least in part, by an aggregation of the values stored within the fragmentation-count fields

19. The flexible command packet of claim 1, further comprising an address field identifying at least one digital address at which access by the flexible command packet is to commence within a corresponding memory device.

20. The Flexible command packet of claim 1, further comprising a plurality of fields, wherein a number of fields is flexibly configured, at least in part, according to a number of memory devices to be accessed.

21. The Flexible command packet of claim 1, further comprising a plurality of fields, wherein a number of fields is flexibly configured, at least in part, according to a number of memory areas to be accessed.
